(19) United States
(12) Patent Application Publication
(10) Pub. No.: US 2014/0021201 A1
(43) Pub. Date: Jan. 23, 2014

(54) SYSTEM AND METHOD FOR MODULAR AND INTERCHANGABLE HUMAN INTERFACE SOLUTIONS FOR PORTABLE ELECTRONIC DEVICES

(71) Applicant: RG Innovations, LLC, (US)

(72) Inventors: Roger S. Benson, La Jolla, CA (US); Gregory P. Benson, Rancho Santa Fe, CA (US); Daniel Wade, El Cajon, CA (US); Elina Benson, La Jolla, CA (US)

(21) Appl. No.: 13/839,909

(22) Filed: Mar. 15, 2013

Related U.S. Application Data
(60) Provisional application No. 61/659,917, filed on Jun. 14, 2012.

(51) Int. Cl. G06F 1/16

(52) U.S. Cl. CPC G06F 1/1613
USPC 220/23.91; 248/176.3

(57) ABSTRACT

A frame for use with a portable computing device is disclosed. In one aspect, the frame comprises an at least partially rigid member that at least partially surrounds the computing device so as to permit receivable attachment or detachment of the portable computing device; and a mounting portion on the back of the rigid member configured to accept a multi-angle positioning device so as to permit rotation of the portable computing device into a user configurable and ergonomic viewing angle in at least one dimension. Other embodiments provide for a handle that optionally doubles as a stand to hold the portable electronic device in a user selected orientation. Still other embodiment provide for a cover for use with the described frame. Still other embodiments provide for a mounting plate for use with the described frame. Still other embodiments provide for an bag or case with an integrated frame.

### CROSS-REFERENCE TO RELATED APPLICATIONS

This application claims priority to and the benefit of U.S. Provisional Patent Application No. 61/659,917 filed in the United States Patent and Trademark Office on Jun. 14, 2012, the entire contents of which are incorporated herein by reference.

### BACKGROUND

1. Field

The described technology relates generally to an accessory for portable electronic devices, and more specifically, to an accessory that mitigates challenges encountered by intensive and/or prolonged use of portable electronic devices.

2. Description of the Related Technology

As computing devices have become smaller and more mobile, consumers are finding vastly expanded uses for the devices in virtually all environments. Where such devices were once confined to desktops in qualified indoor spaces, today's applications are pushing the limits of both device and the human user. Such portable computing devices include smartphones and tablet computers that are generally rectangular, thin and planar, and provide touchscreen input.

There are fundamental interface problems common to such smaller, more portable devices. This need is beyond solving with a narrow product like a device case with limited features. Unlike paper or books, portable devices demand the mitigation of many challenges simultaneously. Such challenges include, but are not limited to, the elements, glare, positioning and viewing angle. Moreover, users are taking devices into challenging field conditions that further strain interface demands such as hands-free use, attaching to other objects, and being functional (particularly fully functional) while the user is in motion. What is needed is a device accessary having the ability to more completely address the requirements of specialty fields of application such as healthcare, aviation and engineering.

For example, just 5 years after the introduction of the Apple iPad, there are hundreds of millions of tablet devices in the market and many thousands of businesses, including most of the Fortune 500, are deploying the units for employees in a vast array of field applications. For example, it has been reported that American Airlines has replaced heavy pilot map cases with tablets loaded with electronic maps. Many restaurants have substituted conventional paper menus in favor of providing guests with tablets. Doctors and healthcare workers are rapidly increasing digitization of charts and records such that many doctors now carry a tablet with them at all times. Finally, engineers, service contractors, construction workers, and students are finding that they can do most of their daily tasks with nothing more than a tablet device, thus being freed from carrying heavy books, drawings, or manuals in a case or backpack each workday.

The dramatically increased use of such portable devices is leading users to employ them in increasingly challenging situations that either impairs full access or risks damaging sensitive human linkages such as wrists, elbows, fingers, backs and or eyes. Consistent with previous machine revolutions, the long-term acceptance and breadth of deployment of these devices will come to depend as equally on physical and ergonomic interface advances as on electronic innovation. Accordingly, certain embodiments disclosed herein are directed at solving problems in the relevant technology by mitigating the challenges encountered by intensive or prolonged use of portable electronic devices like tablets, laptops, ebook readers and game devices. These embodiments may be equally valuable for use with other hand held devices.

### SUMMARY OF CERTAIN INVENTIVE ASPECTS

Some embodiments are directed to a frame for use with a portable computing device, the frame comprising: an at least partially rigid member that at least partially surrounds the computing device so as to permit receivable attachment or detachment of the portable computing device; and a mounting portion on the back of the rigid member configured to accept a multi-angle positioning device so as to permit rotation of the portable computing device into a user configurable and ergonomic viewing angle in at least one dimension. In some embodiments, the member has a lip to retain the computing device via a snap fit. In some embodiments, the portable computing device is at least about the size of at least one of: a U.S. post card, about 4 inches by about 5 inches, U.S. letter size, and A4 size. In some embodiments, the mounting portion is adapted to accept a rotatable handle. In some embodiments, the mounting portion is adapted to accept a turntable. In some embodiments, the turntable engages with the rotatable handle. In some embodiments, the frame further comprises a detachable turntable that mates with the mounting portion. In some embodiments, the frame further comprises a detachable rotatable handle that mates with the mounting portion. In some embodiments, the rotatable handle further comprises a handle carriage and wherein the handle carriage mates with the mounting portion. In some embodiments, the rotatable handle engages with the handle carriage with a torque hinge. In some embodiments, the turntable has a plurality of engageable teeth that mesh with at least one tooth mounted on at least one tension arm. In some embodiments, the rotatable handle can rotate a plurality of angles between about 0 and 180 degrees in a pitch direction with respect to the planar surface of the computing device. In some embodiments, the turntable can rotate between a plurality of angles between about 0 and 360 degrees in a yaw direction with respect to the planar surface of the computing device. In some embodiments, the mounting portion includes a guided track. In some embodiments, the mounting portion provides for multiple degrees of rotation.

Some embodiments provide for a handle that optionally doubles as a stand to hold the portable electronic device in a user selected orientation. Other embodiment provide for a cover for use with the described frame. Still other embodiments provide for a mounting plate for use with the described frame. Still other embodiments provide for an bag or case with an integrated frame.

### BRIEF DESCRIPTION OF THE DRAWINGS

FIG. 1 illustrates a universal frame with turntable and handle carriage accessories attached that permits access to the controls and ports of a tablet device.

FIG. 2 illustrates a universal frame with turntable and handle carriage accessories attached, and further illustrates additional features such as a belt hook on the handle carriage, a speaker duct exit and two harness connection points.

FIG. 3 illustrates a universal frame with a speaker duct exit and two harness connection points, and further illustrates a lip feature to hold the device firmly inside the frame without substantially protruding above the device surface.

FIGS. 4A to 4F illustrates turntable and handle carriage accessories for a universal frame and further provides details of a carriage track mechanism and additional features such as a belt hook and stylus storage cavity on the handle carriage.

FIGS. 5A and 5B illustrates a universal frame with a turntable mechanism, and further illustrates additional features such as the addition of a loudspeaker box and harness connection points.

FIG. 6 illustrates a screen cover that can protect the device controls and ports from the elements.

FIGS. 7A to 7B illustrates a mounting adapter that can permit the frame to be secured to a wall, a stand or vehicles.

FIG. 8 illustrates a case or bag integrated with a frame.

### DETAILED DESCRIPTION

The present development will be described more fully hereinafter with reference to the accompanying drawings, in which exemplary embodiments of the invention are shown. As those skilled in the relevant technology would realize, the described embodiments may be modified in various different ways, all without departing from the spirit or scope of the present invention.

The drawings and description are to be regarded as illustrative in nature and not restrictive. Like reference numerals designate like elements throughout the specification unless context dictates otherwise.

Further, the size and thickness of each component shown in the drawings are shown for understanding and ease of description and may not be to scale, but the present development is not limited thereto. In the drawings, the thickness of layers, modules, regions, etc., may be exaggerated for clarity.

It will be understood that when an element such as a layer, module, region, etc. is referred to as being “on” or “connected” to another element, it can be directly on the other element or intervening elements may also be present. Further, unless explicitly described to the contrary, the word “comprise” and variations such as “comprises” or “comprising,” will be understood to imply the inclusion of stated elements but not the exclusion of any other elements. In addition, in the specification, the word “on” means positioning on or below the object portion, but does not essentially mean positioning on the upper side of the object portion based on a gravity direction.

The embodiments disclosed herein are novel in their ability to provide a “universal” platform on which an essentially unlimited number of interchangeable accessory modules may be attached in order to resolve one or more interface challenges between a device and its user. Some embodiments address the following features, each categorized by a human interface challenge. While reference are made to a universal frame herein, the term is not meant to convey any special meaning.

Carrying, lifting and moving: In some embodiments, a universal frame attached to a device mounts a handle carriage to a turntable adapter on the backside of the device. This frame and accessory combination facilitates carrying the device with its handle fully extended, for example, as one would carry a briefcase, in addition to facilitating lifting and positioning of the device. The turntable enables the user to twist the device to any position from about 0 to about 360 degrees on the viewing plane and/or in combination with a hinge for positioning from about 0 to about 180 degrees about a separate axis, such as the X-axis. In some embodiments, an integrated rail and track allows the handle to slide from its outermost position to a centerpoint, thereby empowering users to adjust position and balance according to their individual needs.

Hanging, standing and propping: In some embodiments, a universal frame attached to a device mounts a handle carriage to a turntable on the backside of the device. In some embodiments, this frame and accessory combination facilitates angling the device from about 0 to about 180 degrees about two separate axes, such as either an X or Y axis. In some embodiments, such as at a fully extended 0 degree position, a handle hole allows the user to hook the device on an object, such as a knob or peg, so the device can hang vertically. In some embodiments, such as at about a 90 degree position, the handle acts as a prop of the far side of the device for about a 10-50, 15-45, or 20-40 degree viewing angle in either portrait or landscape positions of the device. In some embodiments, such as when the handle is at about 90 to about 120 degrees and sitting on an approximately flat surface, the handle acts as a prop or leg to support the device in a vertical or prone position in either portrait or landscape positions of the device. In some embodiments, such as when the handle is at about 90 degrees and positioned at a side farthest from the user, the handle can act as a hook on a user's bent knees, or another similar object, thereby allowing the user to position the device for hands-free use while sitting or lying in a reclined position. In some embodiments, a belt hook allows the user to stow the device on his belt, thereby freeing the user's hands for other activities. In some embodiments, the hook allows for temporary stowage of the device.

Protection, insulation, and ducting of environmental elements: In some embodiments, a universal frame attached to the device protects the device from weather or physical damage to the device or its control surfaces. In some embodiments, the frame is equipped with features or materials to aid insulation from temperature extremes. In other embodiments, the frame is equipped with features that allow for actively ducting air for cooling the device. In some embodiments, the frame, or portion thereof, includes ducting to facilitate the transmission of sound waves from a speaker or microphone attached or incorporated into the device. In some embodiments, the frame, or portion thereof, performs similarly to a loudspeaker box, thereby improving sound quality and/or optimizing one or more electro-magnetic signals. In some embodiments, the frame incorporates materials to reduce, inhibit, or prevent microbial growth on the device or frame. In some embodiments, the frame protects the surface of the device and/or prevent, inhibit, or reduce the interactions that impair the transmission of electro-magnetic signals, including radar reflection.

In some embodiments, the device's screen is protected with an integral cover in the frame. In other embodiments, an accessory such as a removable rigid or flexible boot protects and/or controls orifices on the device. Some embodiments include accessories to the frame, such as one or more lights, pointer, signal boosters, and the like. In some embodiments, one or more of the frame or an accessory is equipped to float by incorporating a suitably buoyant material.

In some embodiments, the cover is plastic, vinyl, molded silicon, rubber, leather, or any suitable material that can safeguard the device from external damage, shock, or impact. In some embodiments, the cover is clear. In some embodiments, the cover has a custom design, personalized photo, or logotype. Such a design, photo, or logotype is optionally located where the frame connects to the cover. In other embodiments, design, photo, or logotype is optionally located where the frame connects to an accessory such as a removable rigid or flexible boot.

Support for peripherals: In some embodiments, a universal frame attached to a device allows for mounting other accessories for solving other types of human interface problems. In some embodiments, the frame is configured to permit screen covers and/or keyboards to lie flat on a display surface. In some embodiments, accessories are connected to the device with a magnet. In some embodiments, the frame permits access to one or more audiojacks for the device and/or one or more system connector ports for a compatible accessory to the device such as earphones, credit card readers, chargers, computers, and the like. In some embodiments, the frame is configured to support connection of accessories that facilitate attaching the device to one or more of tripods, desk stands, articulating arms, wall mounts, or vehicles.

Optimizing ergonomic usage: In some embodiments, a universal frame attached to a device allows for mounting a handle carriage to a turntable on the backside of the device. Such a frame and accessory combination facilitates virtually limitless positioning and viewing angles for the user and device. Thus, some embodiments are customizable. In some embodiments, users optionally adjust positioning and viewing angles to provide a custom, and/or optimal, position for the weight and size of the device in relation to the size and strength of the user's hand. Optimal positions may include a portion of the device resting on a wrist, arm, or leg in addition to a hand. In some embodiments, the handle design and dimensions provide optimal hand ergonomics for the user.

Affixing or rigging: In some embodiments, a universal frame attached to a device allows for mounting one or more straps or harnesses on the backside of the device. Such a frame and accessory combination facilitates attaching the device to other objects such as vehicles, equipment, car seat headrests, or the user's body. In some embodiments, the frame includes mounting hardware and/or connection posts that permit attachments via various clips and/or strap attachments, including Velcro straps. In some embodiments, the accessory is a flexible case that connects to the frame and further includes one or more straps to facilitate carrying the device on the shoulder or back of the user. In some embodiments, a harness connects to the frame to provide a neck or shoulder strap. Optionally, such a neck or shoulder strap transforms into a waist-belt that supports the device hands-free. One can readily envision that such an option affords the user the ability to position the device in multiple ways and places. In some embodiments, the strap allows for the positioning of the device at about a waist-level and further facilitate hands-free use while standing.

### Devices and Configurations:

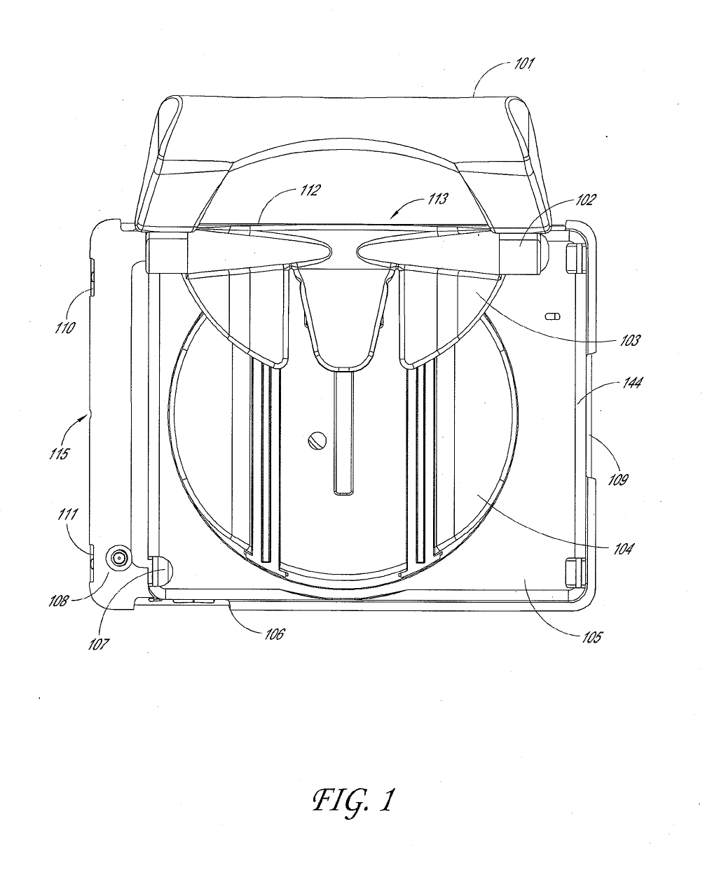

One point of interest relevant to certain disclosed embodiments is the use of a series of user interchangeable modules to solve human interface challenges with portable electronic devices. The exemplary embodiment shown in FIG. 1 (described below) is comprised of the electronic device 113, the device adapter frame module 105, 201 and 301, the turntable module 104 and 204, the carriage module 103 and 205, the handle module 101 and 209, the cover module 601 the adapter module 701 and the case module 808. As can be readily understood from FIG. 1, the universal frame is both modular and configured to permit user access to the controls and ports of a device, such as a tablet.

In some embodiments, the frame is sized specifically to clamp the edges of a IBM laptop computer, an Apple iPad tablet, an Amazon Kindle ebook reader, a Nokia cell phone or any other portable device (further described below). Alternatively, the frame is a universal size and simply glued to the backside of a device. As further described below, the frame includes one or more holes to allow users access to device controls such as the power button, the volume control, the system connector, the speaker, the sim-chip portal, the audio jack, the microphone, the camera, and other similar device controls and features. Some configurations may include one or more cavities with an anchor bar for the purpose of attaching hooks, straps or belts. Other configurations include larger cavities, with or without enclosure doors, that store auxiliary battery, extension speaker, system charger and cable, a floatation device, or are simply empty. In some embodiments, devices such as credit card readers or thermal printers are integrated in the frame or one of the accessory modules. The frame can be configured with channels to duct air, sound waves or other electro-magnetic radiation. The materials could be metal, plastic, rubber and/or coated with organic prohibiting substances or radar and/or heat reflection/absorption material.

Another point of interest relevant to certain disclosed embodiments emerges from the allowance of a high degree of handle mobility: a mechanism for holding a handle that extends not from the device but perpendicular to the user and or back of the device. This unconventional handle orientation permits the user to maintain a relatively straight wrist while holding the handle more like a handshake with the crossbeam pressing against the inside of the fingers and the handle legs facing back toward the device against the palm. The base of the palm thus supports a large portion of the weight against the wide leg-base of the handle. By facilitating many different holding positions, users can be empowered to optimize weight distribution and may minimize stress to joints and ligaments that cause problems like carpal-tunnel syndrome.

Another point of interest relevant to certain disclosed embodiments is a combined handle mobility with constant-force hinges otherwise known as torque hinges. When using the handles conventionally, the hinge tension provides a balance to the weight of the device and system modules and therefore reduces, lessens, minimizes, or eliminates muscle stress. In addition, the combination of handle size and tension of the hinges permits the handle to transform into an articulating base stand capable of holding the device in an upright or prone position in relation to a flat surface such as a tabletop. Alternatively, with the handle angled perpendicular to the device surface and downward from the side of the device farthest from the user, the handle functions as a prop-stand lifting the back edge to between about 10 and about 45 degrees in relation to the table.

Using the handle carriage and turntable modules in the manner described can empower the user to configure the system-equipped portable device in an essentially infinite number of angles and positions relative to his or her body. In some embodiments, the handle rotates at least about 180 degrees in the carriage in relation to the surface of the device. In some embodiments, the handle travels linearly from its outermost position beyond the edge of the device like a handle on a briefcase, along the track embedded in the turntable to the opposite end if the track and well past the center position of the device. Additionally, some embodiments have a turntable that permits the handle to be rotated about 360 degrees, thus allowing the user to view the device in portrait, landscape or angles in between.

### DETAILED DESCRIPTION OF THE FIGURES

Hereinafter, a universal frame and optional accessories according to exemplary embodiments will be described in detail with reference to FIGS. 1-8.

FIG. 1 illustrates universal frame embodiments with turntable and handle carriage accessories attached. Portable electronic device 113 is mated to universal frame 105. Such a mating can be facilitated by magnets, clips, binders, etc., with one or more of such connectors being located generally around the edges of universal frame 105. In some embodiments, universal frame 105 is formed to fit snuggly around one or more corners or edges of electronic device 113; for example, with a snap fit. In FIG. 1, universal frame 105 is represented as being modular, and includes a handle 101 connected to a handle frame 102 with a further connection to a handle carriage 103. Universal frame 105 further has a cutout 106, which allows access to a volume controller for the device, a cutout 108, which allows use of a device's camera, a cutout 109, which allows for a system connecter, a cutout 110, which allows for user access to an audiojack on the device, cutout 111, which allows for user access to a power switch on the device, and cutout 115, which allows user access to a microphone. Universal frame 105 is further configured with turntable 104. Turntable 104 represents one type of a mounting portion on the back of universal frame 105, the frame and turntable being configured to allow multi-angle positioning of portable electronic device 113 so as to permit rotation of portable electronic device 113 in user configurable and ergonomic viewing angles. It will be understood that the mounting portion could be a stationary portion that allows for attachment and detachment of moveable portions like the turntable or handle. Universal frame 105 is optionally fitted with speaker output holes 114. Speaker output holes 114 are located at one or more edges of universal frame 105 in some embodiments. In other embodiments, speaker output holes 114 are located in proximity to one or more speakers on portable electronic device 113. Universal frame 105 is optionally fitted with a cover attachment optionally having cover attachment cutout 112 to accommodate user access to a sim portal. Cover attachment cutout 112 is located at one or more edges of universal frame 105 in some embodiments, preferably in proximity to one or more sim portals and configured to allow user access to the one or more sim portals. Universal frame 105 is optionally configured with harness anchor point 107. As FIG. 1 illustrates, harness anchor point 107 is located in proximity to a corner of universal frame 105 in some embodiments. In other embodiments, harness anchor point 107 is located at two or more points of universal frame 105, thereby permitting the user to select an appropriate harness point for the desired use of portable electronic device 113. Universal frame 105 is optionally configured with handle 101, connected at one or more points to universal frame 105 by handle frame 102. Optionally, universal frame 105 includes handle carriage 103. In some embodiments, one or more of cutouts 106, 108, 109, 110, 111, 112 and 115 are optionally missing. In some embodiments, less than all the above described modules are present on universal frame 105.

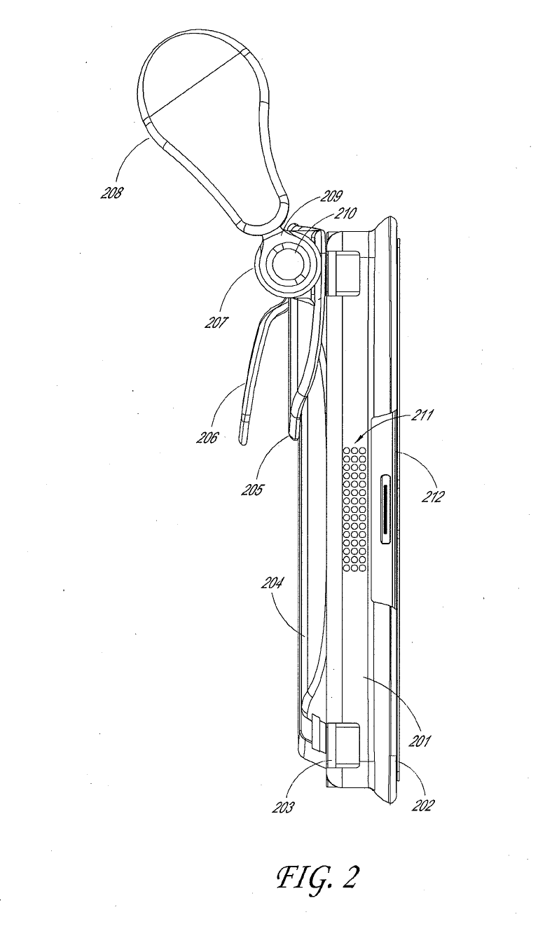

As illustrated in FIG. 2 with a side view, universal frame 201 allows for additional accessories to be mounted thereto such as a belt hook on the handle carriage, a speaker duct and sound exit, and harness connection points. Describing FIG. 2 in more detail, universal frame 201 contains, on at least one edge, speaker duct 211, configured to allow sound to exit from a portable electronic devices speakers. FIG. 2 also illustrates one location for system connector cutout 212 in universal frame 201. Moreover, the side view of FIG. 2 allows for the visualization of lip 202, which is one option for snugly holding the device 113 in universal frame 201. The side view also exhibits one possible location for harness anchor point 203 in the universal frame 201.

In FIG. 2, handle carriage 205 is connected to universal frame 201 via hinge anchor point 207, located on carriage 205. Belt clip 206 is optionally present and connected to hinge anchor point 207. The side of optionally padded handle 208 is also shown in FIG. 2, connected to hinge anchor point 207 via handle frame 209. Handle frame 209 contains a hinge anchor (described below) and surrounds torque hinge 210. Turntable 204 is also indicated in FIG. 2, showing one possible location on the backside of frame 201 and in relationship to handle carriage 205.

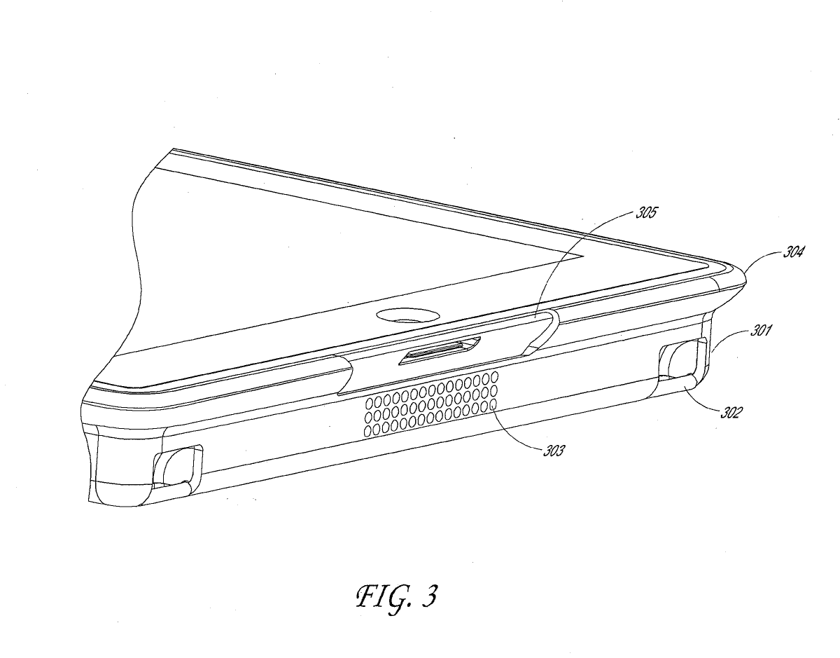

FIG. 3 is a close-up view of one side of universal frame 301, generally illustrating a universal frame with speaker duct exit 303, generally located in the midpoint of the side of universal frame 301. For illustration purposes only, one location of system connector cutout 305 is at the midpoint of one edge of universal frame 301 and generally above speaker duct 303. Also represented in FIG. 3 are two harness anchor points, 302, generally located at the two illustrated corners of universal frame 301. FIG. 3 also provide a close-up view of lip 304, which has a snug fit with the portable electronic device. Lip 304 is particularly well-fitting at one or more, two or more, three or more, or four corners of the portable electronic device and allows the device to fit firmly within universal frame 301. In some embodiments, lip 304 continues snugly around one or more, two or more, three or more, or four edges of the portable electronic device.

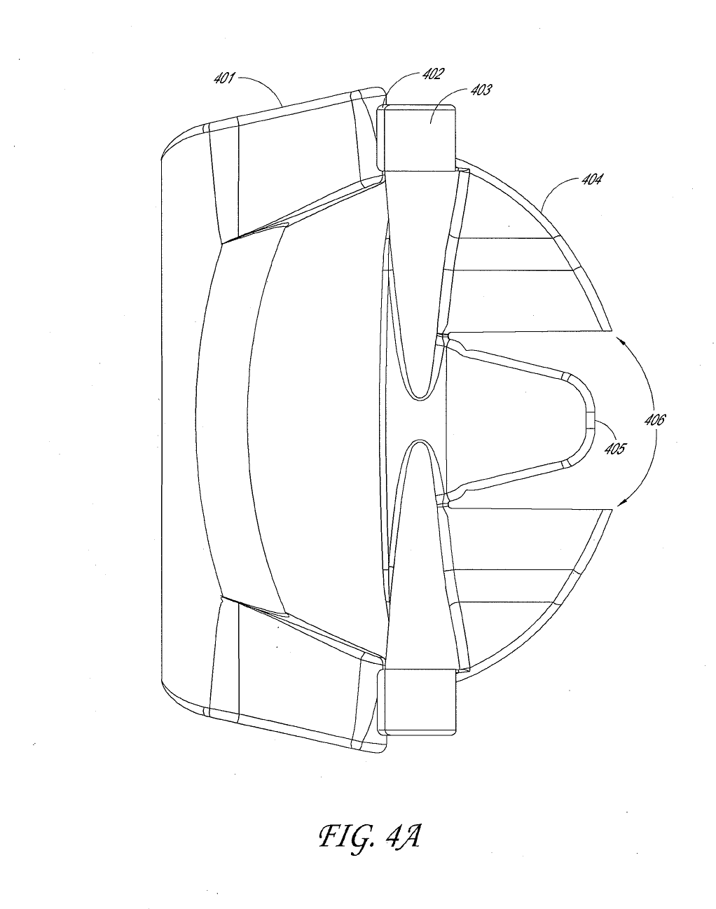

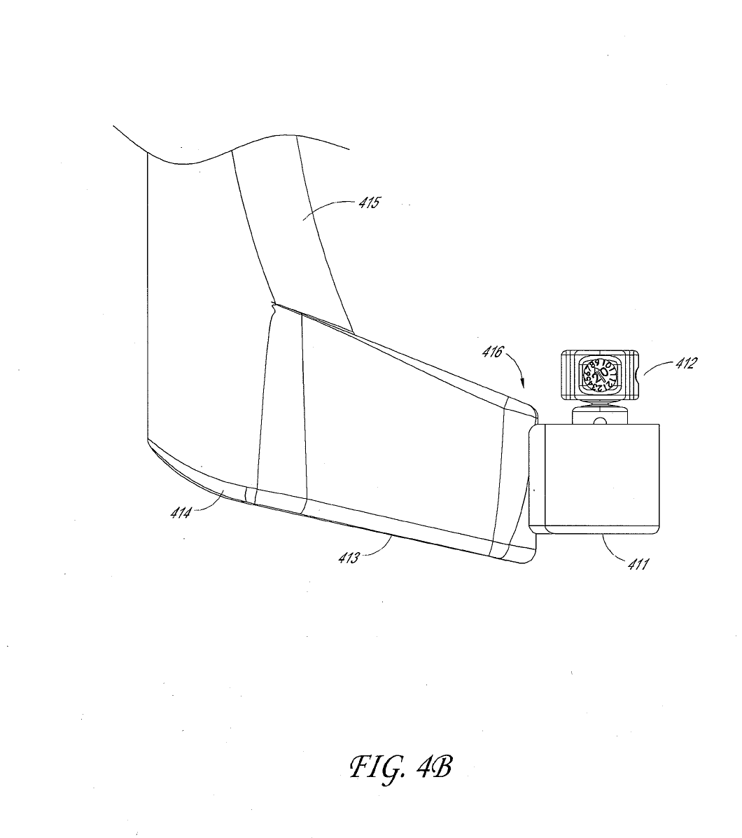

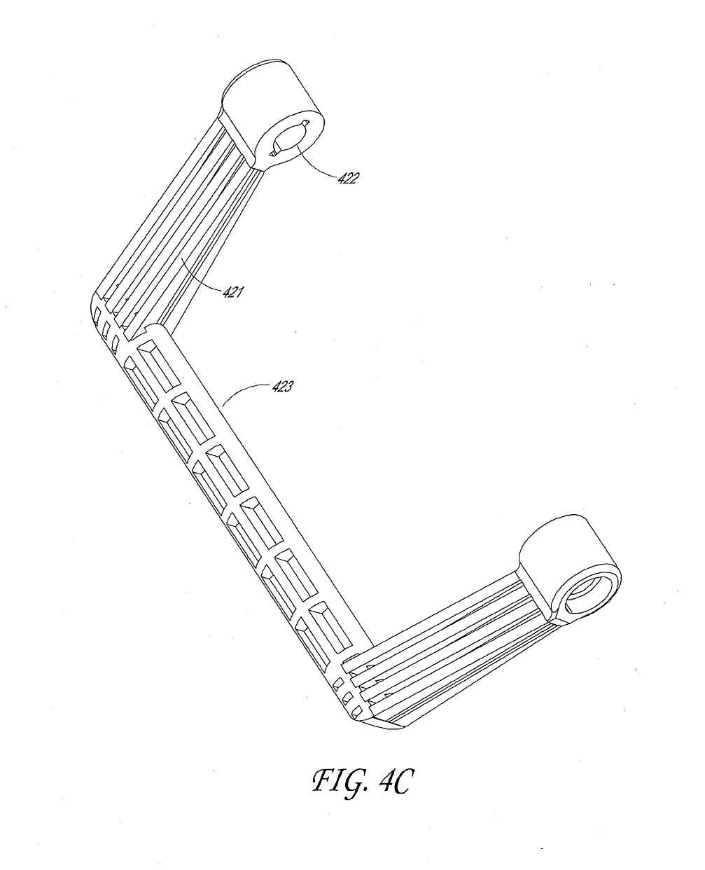

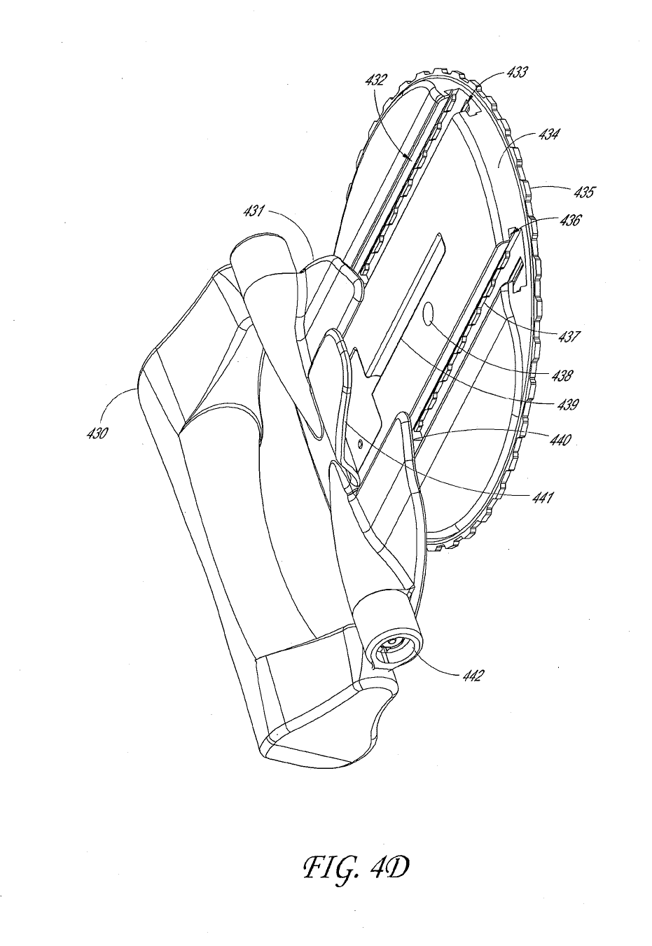

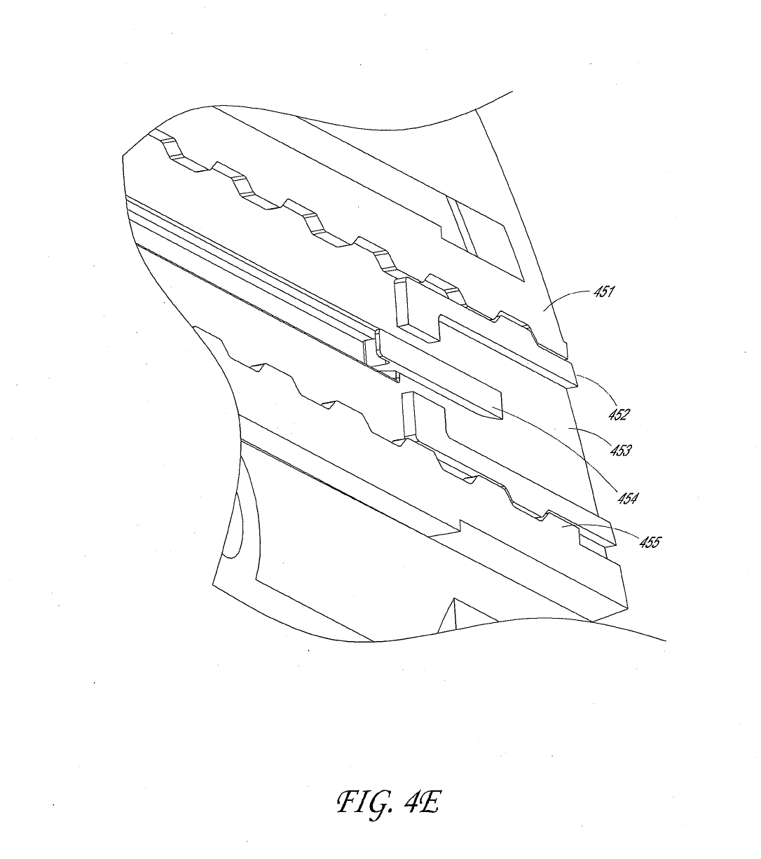

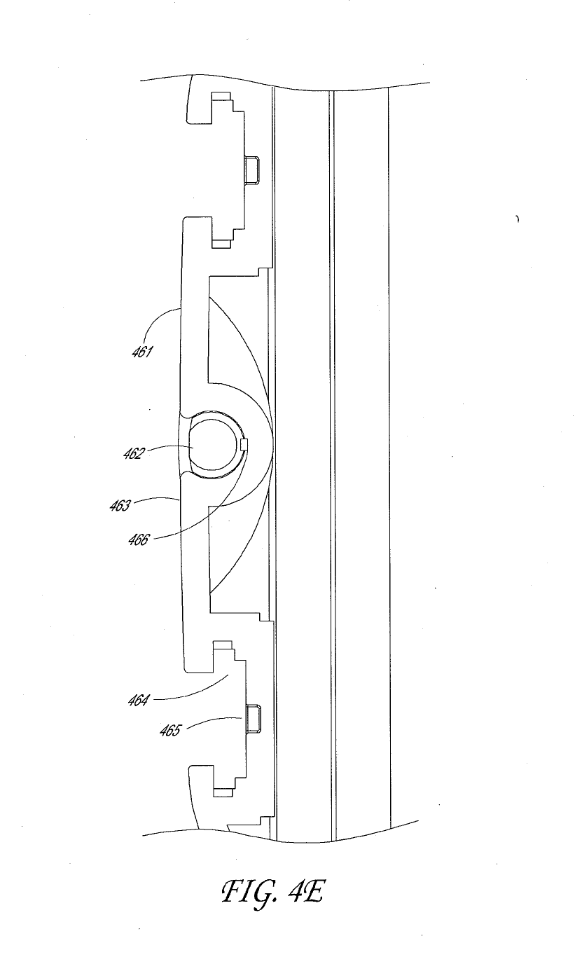

FIG. 4A is an illustration of the handle, hinges, and carriage. As illustrated in FIG. 4A, handle 401 connects to one or more, and preferably two hinges 403 via one or more, and preferably two handle frames 402. Handle frames 402 also contain hinge anchors (not shown). In various embodiments, the hinges are torque hinges and although referred to as such are not limited to be of such type. Torque hinges 403 are connected to handle carriage 404, which contains one or more, and as illustrated, preferably two rails 406. Rails 406 are configured to fit in one or more tracks on a turntable (not shown) via clamping or gliding into snug fitting tracks in the turntable. Also illustrated in FIG. 4A is belt hook 405, located generally in the center of handle carriage 404 and flanked in this two-dimensional view by rails 406.

FIG. 4A represents but one of many potential accessory modules for universal frame 105, with FIG. 4A illustrating handle carriage 404 as the exemplary accessary module. In some embodiments, an ergonomically designed handle cushion 401 is attached to the handle frame 402 that includes mounting brackets on each foot for affixing a hinge 403. As previously described, in some embodiments the hinge is a constant force torque hinge 442. Such hinge type allows for movement via force and stability once moved to a desired position. Handle frame 402 optionally includes reinforcing ribs for one or more, or all, surfaces to provide additional strength. In some embodiments, the handle is permanently affixed to a carriage 404 equipped with two rails 440 and 464 (FIG. 4F, described below) with spring-loaded ratchet mechanisms 452 (FIG. 4E, described below) that facilitate linear movement when attached to another module or frame adapter equipped with tracks that match the dimension of the carriage rails 451 (FIG. 4E, described below). In some embodiments, when the carriage is inserted into the module's tracks 432 (FIG. 4D, described below), the teeth along the inside of each track 455 (FIG. 4E, described below) engage with the spring-tensioned ratchet bars 452 (FIG. 4E, described below) in the carriage to provide even resistance when sliding linearly along the track, thereby preventing uncontrolled movement. In some embodiments, a flexible arm keeps the carriage from travelling beyond the end of track 454 (FIG. 4E, described below). In some embodiments, carriage 404 includes a simple belt hook 405 at the center of carriage 404. Other variations include, but are not limited to spring-actuated clips and/or other anchoring mechanisms known in the field.

FIG. 4B is a close-up view of handle frame 411, containing a hinge anchor. Torque hinge 412 is clearly shown in connection with the hinge anchor of handle frame 411, located in close proximity to tapered handle leg 416. From the perspective of FIG. 4B, one can clearly see the padded exterior of the handle, indicated as 413, a tapered handle corner 414, and a tapered handle crossbar. In some embodiments, the handle corner, crossbar, and leg are optionally tapered.

In some embodiments, the handle described in FIG. 4B comprises a padded exterior 413 made of foam or organic filaments, wrapped fully around a reinforced handle frame 411 with integrated hinge 412 on each leg 416. In FIG. 4B, a barrel type hinge is shown, but other hinges can be used to similar effect. In some embodiments, the handle provides ergonomic functionality in that each corner 414 is the widest point on the handle and tapers toward both the middle of the horizontal bar 415 and downward to each leg 416. This configuration is designed to fit a human hand in multiple holding positions with significantly less stress than alternative designs. In other embodiments, handle configurations comprise an ergonomic sphere that fits the middle of the palm, a sphere that collapses flat into the frame and an elastic pocket that supports a portion of the weight and balance to the backside of the hand.

FIG. 4C is a close-up view of a handle embodiment without padding to allow for visualization of the handle's components. The handle has two legs with reinforcement ribs 421, two hinge anchor points 422, and handle crossbeam 423 with reinforcement ribs connecting the handle legs. The hinge anchor points on the handle frame are configured to receive a hinge anchor. In some embodiments, the handle frame illustrated in FIG. 4C consists of a horizontal crossbeam 423 and two legs 421 that angle outward by degrees of 10, 12, 14, 16, 18, 20, 22, 24, 26, 28, 30, or about any of the aformentioned numbers, or about a range bounded by any two of the aforementioned numbers to hinge mounting point 422 at each end. In some embodiments, hinge mounting point 422 is a tube with flanges to accept a press-to-fit torque hinge. In other embodiments, standard mechanisms for mounting may be used.

FIG. 4D is a close-up view of a handle embodiment and a turntable embodiment illustrating one form of connection between the handle and the turntable. As illustrated in FIG. 4D, handle carriage 431 is connected to torque hinges 442 (second torque hinge obscured by the perspective view), which in turn are connected to an optionally padded handle 430. Handle carriage 431, in this illustrated embodiment, has two rails 440, the rails can be referred to as handle carriage track rails. Rails 440 have one or more protrusions configured to grip turntable 434 via removal arm trench 433 in turntable 434, along with optional turntable ratchet teeth 437 located in arm trench 433. Arm trench 433 is optionally flanked on at least one edge with a toothed pattern, indicated at 432. To afford consistent and optimal insertion of rails 440 into turntable 434, stopper track 436 is located generally at the interface of the edge of turntable 434 and the end of removal arm trench 433. The perspective of FIG. 4D also illustrates an optional stylus storage cavity, 439 and optional hole 438. In some embodiments, hole 438 is a treaded hole, approximately ¼ inch, and allows for accessory attachments to be mounted on turntable 434. One of skill in the relevant technology will understand that the size and location of hole 438 is only limited by the relative dimensions of the turntable and the nature of the accessory to be attached to the turntable. The edge of turntable 434 is illustrated as having turntable ratchet teeth 435 which facilitate user orientation of the portable electronic device (not shown). Also illustrated in FIG. 4D is belt clip 441 attached to handle carriage 431, generally in the center relative to the handle and handle carriage.

The frame adapter and handle may optionally employ a turntable module as illustrated in FIG. 4D in order to support handle travel from side to side and or handle rotation on the same plane as the surface of the device. In one embodiment of turntable 434, an interchangeable interface is provided between the frame adapter and handle carriage 431. In some embodiments, turntable 434 is akin to a disc that can be anchored in the frame adapter, also having a mechanism for connecting another module to its surface and one or more additional and optional accessories and features. In FIG. 4D, turntable 434 is equipped with ratchet teeth along the perimeter of the disk-shaped turntable, indicated at 435.

FIG. 4E is a close-up view of handle carriage guide track 451, located in turntable 434. When inserted into the adapter frame's disk track, the ratchet teeth 455 engage with spring-tensioned ratchet bar 452 to provide even resistance when turntable 434 is rotated, thus preventing uncontrolled movement. Optionally, the track 451 contains guides for rails 440 or stopping mechanisms, such as stopper track 346, and strips of material 453 to reduce friction, such as Delrin. FIG. 4E also illustrates a carriage removal arm 454, located between ratchet bars 452 in a handle carriage track foot. Carriage removal arm 454 facilitates release of handle carriage 431 from turntable 434.

FIG. 4F is a close-up side view of turntable 434, illustrating stylus 462, located generally in the center of turntable 434 in the area denoted stylus storage cavity 463. Optionally, material 466 is included in and around the inner edge of stylus storage cavity 463. Material 466 can be any material affording some degree of friction between stylus 462 and stylus storage cavity 463. FIG. 4F also illustrates the guide track for the handle carriage, 464, and the handle carriage removal arm trench, 465, each of which are located above and below stylus storage cavity 463 in the illustrated view.

Additionally, in one embodiment and as illustrated in FIG. 4F, turntable 434 has an elevated center, 461, to allow for stylus storage cavity 439 (also depicted as 463) for a stylus or writing device 462. The cavity may contain bumps, ribs or rubber inserts 466 to prevent the stylus or writing device 462 from falling out of the cylindrical cavity. Additionally, the elevated center area contains a ¼ inch threaded hole 438 (FIG. 4D) to permit the attachment of other equipment or mounting the entire system to a standard tripod or Gorilla brand flexible stand equipped with a ¼ inch bolt.

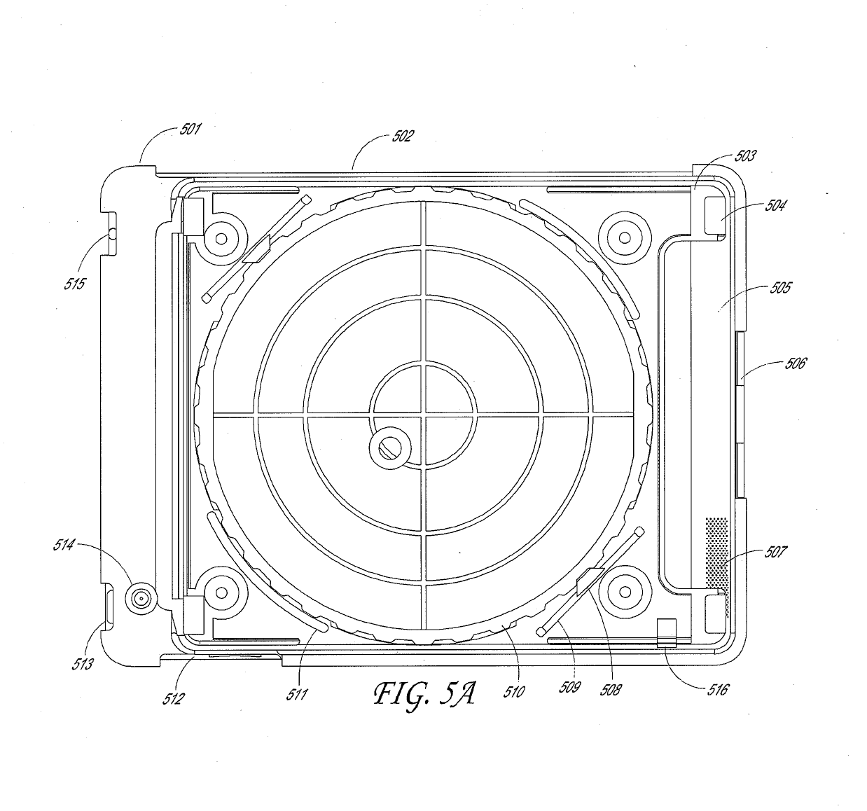

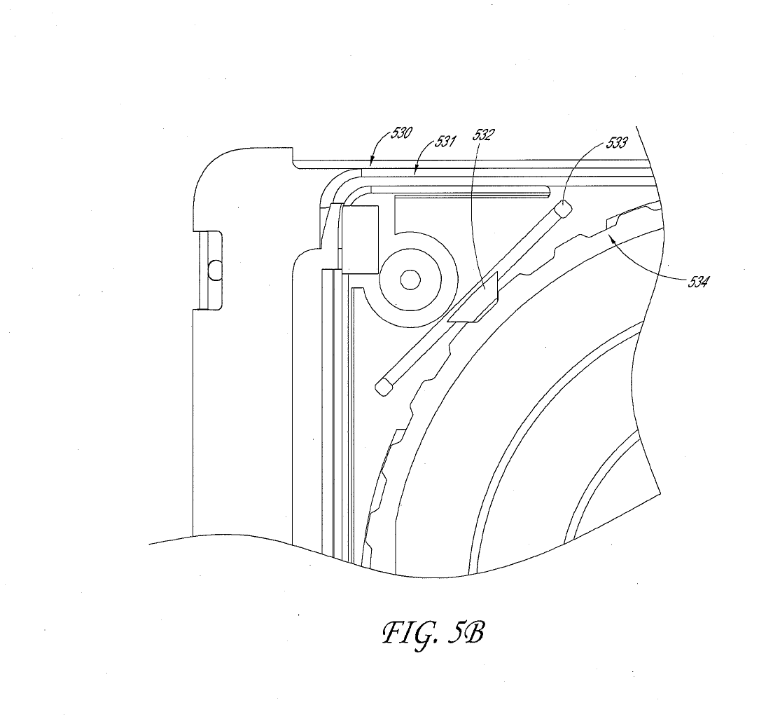

FIG. 5A illustrates a bottom plan view of universal frame 501, with FIG. 5B representing a close-up view of one corner of frame 501. In the upper edge of frame 501 is located frame cutout 502 to accommodate for cover attachment or user access to a sim portal in the portable electronic device. FIG. 5A illustrates the insertion of turntable 510 and 534 (when present in frame 501) anchored to frame 501 and 530 via removable turntable mounting cover 503 and 531. Turntable 510 protrudes through a hole in frame 501, resting in a generally circular track and being held in position by guides 511, located diagonally across from each other about turntable 511, and generally located in two corners of frame 501. In the opposing two corners are spring-tensioned arms 509 and 533 with teeth 508 and 532 that generally match the geometry of turntable ratchet teeth 435. The ratchet mechanism created by the tension arms and gear mechanism generally provide modest rotational resistance to prevent undesired movement of the device.

In one embodiment, the outside surface of the frame adapter FIG. 5A is configured to accept turntable module 510, the module being held in place with by removable cover plate 503 and formed in such a way as to provide ducting for sound waves from device speaker 507. In some embodiments, one or more, two or more, three or more, or four cavities 504 are present substantially in the corners of frame 501 to allow a user to connect straps or a harness. Frame 501 has cut away sections specific for each device brand and model to allow access to controls and ports such as: screen covers or keyboards with magnetic anchors 502, system or power connector port 506, volume controller 512, power switch 513, camera lens 514 and audio jack 515. In some embodiments, frame 501 incorporates reinforced sections, such as security anchor point 516, to facilitate secure anchoring of frame 501 to another object to prevent theft. In some embodiments, the reinforced sections allow for use of an industry standard solution like the Kensington Security Slot™.

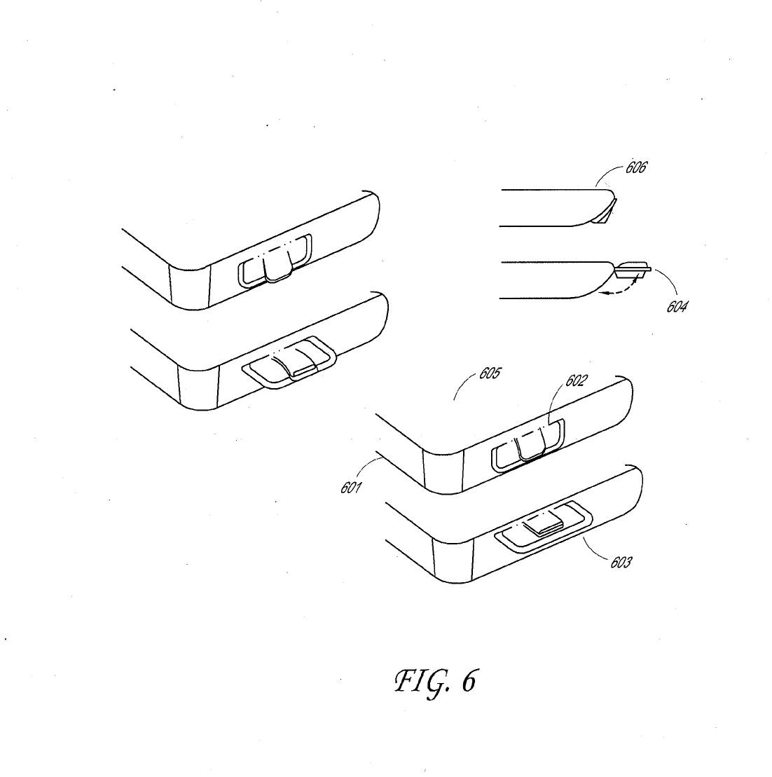

FIG. 6 illustrates a manner in which a device screen is protected with either a rigid or flexible cover 606 that substantially wraps around one or more edges or the perimeter of frame 601 and device 605. In some embodiments, cover 606 utilizes a snap mechanism (if generally less flexible material is used, such as plastic) or a pressure fit (if a generally more flexible material is used, like rubber or silicone). The rim of cover 606 has hinging access points 602 and 603 to cover controls and/or device ports. In this manner such hinging access points can be lifted easily, with optional locking mechanisms when extended and/or closed, the locking mechanism returning substantially to its original position by snapping into the opening of frame edge walls 604. The surface of the cover 606 snaps or is glued into the perimeter boot where such material could be clear plastic to permit use of the screen with the cover in place or the material could be any rigid plastic or soft fabrics like leather or vinyl. In some embodiments, the cover material is optionally personalized with user selected colors, fabrics, designs, images, or logotype. In some embodiments, cover 606 encloses a keyboard (such as an ultrathin keyboard), the keyboard wirelessly communicating with device 605 or by way of an adapter in frame 601.

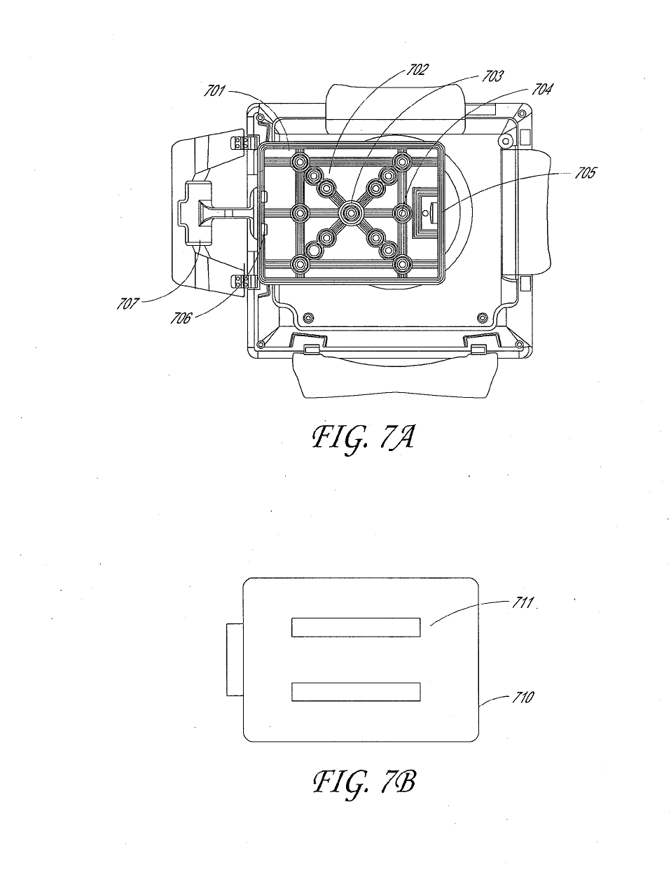

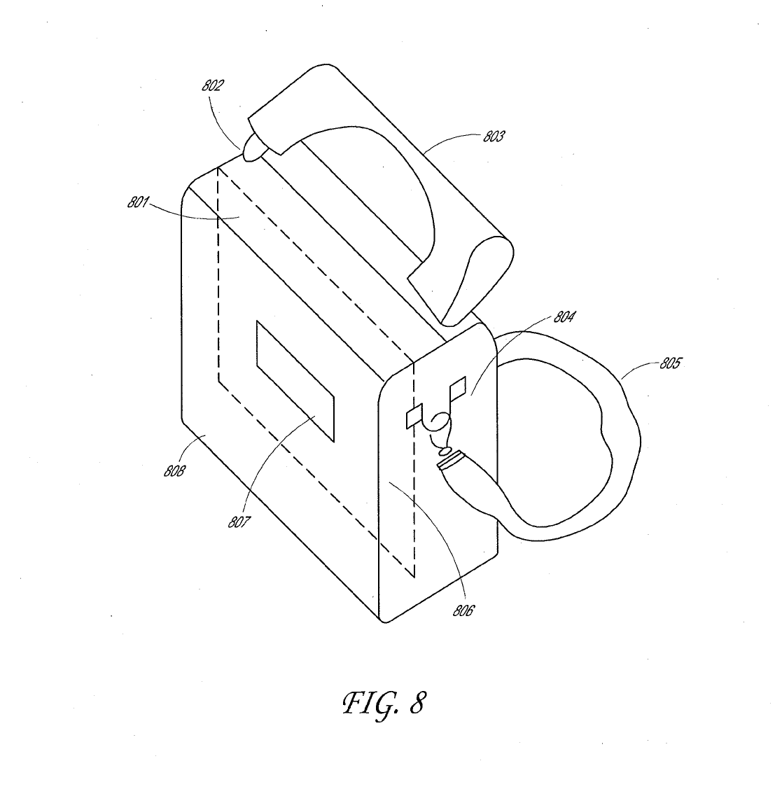

FIGS. 7A and 7B illustrate one of several adapters for frame 105. In FIGS. 7A and 7B, plate 701 (optionally reinforced) is configured to connect to a frame or handle module on one side while the opposite side is configured to be anchored to a wall, a tripod or a VESA compatible stand or mounting hardware. Alternatively, the plate can be mounted on the mounting portion of the frame. Plate 701 can be made from plastic or metal and drilled with at least four holes that correspond to the VESA standard such as 75 mm and 100 mm, denoted in FIG. 7A as 702. The ¼ inch threaded hole 703 allows a user to attach with devices or tripods equipped with ¼ inch standard bolts. In some embodiments, plate 701 has at least two ¼ inch holes that permit plate 701 to be mounted, for example by one or more screws, to a wall or other surface. At one or more ends of plate 701 is screw mount 706, which allows for the extension of cradle 707. Cradle 707 is designed to secure or capture the frame handle (discussed in earlier figures) firmly, yet still allow easy removal by the user. In FIG. 7B, the frame side of plate 710 has one or more, and preferably at least two rails 711 that fit into tracks 451 (discussed above) on turntable 461 (discussed above). Alternatively, the tracks could be directly formed on the frame to be the mounting portions so that no turntable would be required.

FIG. 8 illustrates an additional embodiment, in which hand bags or cases are substantially integrated with frame 801. In one embodiment, the portable electronic device (discussed above) and frame 801 is surrounded on one or more, two or more, or several sides by either a rigid or soft case material having open gaps or zippered enclosures 802. Frame handle 803 can be extended or collapsed into the bag. In some embodiments, the case is equipped with one or more, or at least two rings or loops 804 to facilitate attachment of hooks or straps 805 to the hand bag or case. In some embodiments, the inside of the hand bag or case optionally has one or more pockets for storage and an optionally rigid base to protect the device and help it stand upright (generally represented as 806). In some embodiments, the exterior of the hand bag or case optionally has one or more pockets or zippered pouches for storage. The hand bag or case may further include openings or doors to allow the device to operate some features such as a camera, microphone, light, or any other similar function that requires access through the hand bag or case wall to work.

While the embodiments of the universal frame as disclosed have been configured to allow use of optional accessories such as speakers, microphones, etc., other peripheral accessories such as mouse pointer devices, stylus/writing pad devices, numerical keypads, keyboards, and like devices are equally applicable while remaining well within the scope of the disclosure.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A frame for use with a portable computing device, the frame comprising:
an at least partially rigid member that at least partially surrounds the computing device so as to permit receivable attachment or detachment of the portable computing device; and
a mounting portion on the back of the rigid member configured to accept a multi-angle positioning device so as to permit rotation of the portable computing device into a user configurable and ergonomic viewing angle in at least one dimension.

2. The frame of claim 1, wherein the member has a lip to retain the computing device via a snap fit.

3. The frame of claim 1, wherein portable computing device is at least about the size of at least one of: a U.S. post card, about 4 inches by about 5 inches, U.S. letter size, and A4 size.

4. The frame of claim 1, wherein the mounting portion is adapted to accept a rotatable handle.

5. The frame of claim 1, wherein the mounting portion is adapted to accept a turntable.

6. The frame of claim 5, wherein the turntable engages with the rotatable handle.

7. The frame of claim 4, further comprising a detachable turntable that mates with the mounting portion.

8. The frame of claim 5, further comprising a detachable rotatable handle that mates with the mounting portion.

9. The frame of claim 8, wherein the rotatable handle further comprises a handle carriage and wherein the handle carriage mates with the mounting portion.

10. The frame of claim 9, wherein the rotatable handle engages with the handle carriage with a torque hinge.

11. The frame of claim 7, wherein the turntable has a plurality of engageable teeth that mesh with at least one tooth mounted on at least one tension arm.

12. The frame of claim 8, wherein the rotatable handle can rotate a plurality of angles between about 0 and 180 degrees in a pitch direction with respect to the planar surface of the computing device.

13. The frame of claim 7, wherein the turntable can rotate between a plurality of angles between about 0 and 360 degrees in a yaw direction with respect to the planar surface of the computing device.

14. The frame of claim 1, wherein the mounting portion includes a guided track.

15. The frame of claim 1, wherein the mounting portion provides for multiple degrees of rotation.

16. The frame of claim 4, wherein the rotatable handle can be configured as a stand to hold the portable computing device in an upright position.

17. The frame of claim 1, further comprising a cover that fits onto the frame and protects the front of the portable computing device.

18. The frame of claim 1, further comprising a mounting plate that engages with the mounting portion.

19. The frame of claim 1, further comprising a bag having a handle and configured to receive the frame and portable computing device.
